(19) United States
(12) Patent Application Publication
(10) Pub. No.: US 2007/0214396 A1
(43) Pub. Date: Sep. 13, 2007

(54) Round-trip resolution of customer error reports

(75) Inventors: Kieran V. McKeogh, San Rafael, CA (US); James B. Souder, Novato, CA (US); Robert E. Maguire, Sausalito, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: Autodesk, Inc.

(21) Appl. No.: 11/370,460

(22) Filed: Mar. 8, 2006

(51) Int. Cl. G06F 11/00

(52) U.S. Cl. 714/57

(57) ABSTRACT

A method, apparatus, and article of manufacture for providing round-trip resolution to customer error reports (CERs). This improves on CERs in supporting quality assurance for software systems by providing appropriate responses to the customers. The result is a novel technique for improving software quality and customer satisfaction.

### BACKGROUND OF THE INVENTION

1. Field of the Invention

The present invention generally relates to a system for diagnosing computer programs, and, in particular, to providing a round-trip resolution of customer error reports.

2. Description of the Related Art

Software programs often fail by “crashing” or reaching error conditions that cause them to terminate. In order to improve product quality, it is important to diagnose the reasons for failure.

It is well known for software vendors to provide users with a set of tools for capturing and analyzing program crash data. In their simplest form, these tools comprise an error reporting mechanism that presents the users with an alert message that notifies them when a crash occurs and provides an opportunity to forward customer error reports (CERs) to the vendor for further analysis. The vendor can then use the forwarded CERs to troubleshoot problems, ultimately leading to more robust and crash-resistant programs.

The weakness of the CERs is the lack of a response from the vendor to the user. Field failures are not desirable, and delays between the discovery of an error and its correction by the vendor can be costly for users.

Program failures cause a good deal of user frustration and angst. Moreover, fatal errors obviously result in immediate data and productivity losses. Because users may not know the exact cause of a crash, these problems may cause them to avoid certain software procedures and commands, resulting in ongoing productivity losses.

Moreover, users do not know whether their problem has been fixed in future product revisions and/or service packs. As a result, the user may not know of the existence of a revision, service pack, or whether that revision or service pack fixes their problem.

Leaving a user in such a state may erode their confidence in both the product and the vendor. Providing feedback on the state of problems reported in the CERs will tend to bolster confidence.

Microsoft, in particular, has developed significant customer error reporting capabilities. Microsoft products solicit error information and has the ability to alert a user as to whether a fix is currently available for a reported problem. However, Microsoft does not have the ability to send out a customized email listing resolved problems to users, when a new product version or service pack becomes available.

Thus, there is a need in the art for a mechanism where the CERs generated by a program failure includes information on the user, and provides a response to the user, so that the user knows when those program failures have been fixed.

### SUMMARY OF THE INVENTION

To address the requirements described above, the present invention discloses a method, apparatus, and article of manufacture for providing round-trip resolution to customer error reporting.

Customer error reports concerning program failures are received from one or more customer computers at a vendor computer. The customer error reports may include, inter alia, a description of the steps necessary to reproduce the error, an email address for the user, and authorization to send the customer error report, as well as an identifier of the program that failed and an identifier of the customer computer.

The customer error reports are analyzed in the vendor computer to determine whether corrections exist for the program failures. The vendor computer then responds to the customer error reports by sending a resolution report including the corrections for the program failures to the customer computers. The resolution report acknowledges the customer error reports, reflects a current status of the customer error reports, and may include a link to download a new version or service pack for the program. The resolution report may be sent in real-time for display to the customer computer, or the resolution report may be sent in an email to the customer computer.

### BRIEF DESCRIPTION OF THE DRAWINGS

Referring now to the drawings in which like reference numbers represent corresponding parts throughout:

FIG. 1 schematically illustrates an exemplary hardware and software environment used in the preferred embodiment of the present invention;

FIG. 2 is a block diagram that illustrates the operation of the preferred embodiment of the present invention; and

FIG. 3 illustrates one embodiment of a report transmitted to a customer's computer according to the preferred embodiment of the present invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

The present invention improves on customer error reports (CERs) in supporting quality assurance for software systems by providing appropriate responses to the customers. The result is a novel technique for improving software quality and customer satisfaction.

Hardware and Software Environment

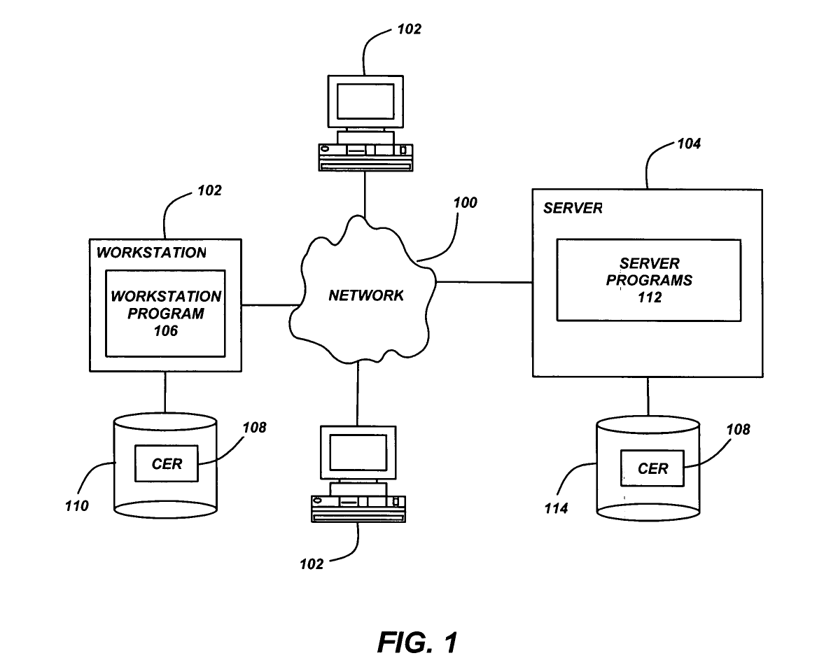

FIG. 1 schematically illustrates an exemplary hardware and software environment used in the preferred embodiment of the present invention. The present invention is usually implemented using a network 100 to connect one or more workstation computers 102 to one or more of the server computers 104. A typical combination of resources may include workstations 102 that are customer computers and comprise personal computers, network computers, etc., and servers 104 that are vendor computers and comprise personal computers, network computers, workstations, minicomputers, mainframes, etc. The network 100 coupling these computers 102 and 104 may comprise a LAN, WAN, Internet, etc.

Generally, the present invention is implemented using one or more programs, files and/or data that are executed, generated and/or interpreted by the workstations 102 and/or the servers 104. In the exemplary embodiment of FIG. 1, these computer programs and data include a workstation program 106 executed by one or more of the workstations 102, and one or more CERs 108 stored on a data storage device 110 accessible from the workstation 102. In addition, these computer programs and data include one or more server programs 112 executed by the server 104, as well as one or more CERs 108 stored on a data storage device 114 accessible from the server 104.

In this context, the workstation program 106, when it “crashes” or fails or reaches an error condition that causes it to terminate, generates the CER 108 that is stored on the data storage device 110. The CER 108 may comprise a “full dump” or “minidump” or “core dump” file, or any other information that may be considered useful by the vendor. Generally, the workstation program 106 includes an error reporting mechanism that presents the users with an alert message that notifies them when a failure occurs and provides an opportunity to forward the CER 108 to the server 104 operated by the vendor for further analysis.

The CERs 108 concerning the workstation program's 106 failure are collected by the server 104 from the workstations 102, and the server programs 112 executed by the server 104 store the CERs 108 on the data storage device 114 accessible from the server 104. The server programs 112 provide various tools for use in analyzing the CERs 108 associated with the workstation program 106, in order to determine patterns of errors that lead to failures in the workstation programs 106, thereby leading to more robust and crash-resistant workstation programs 106.

Each of these programs and/or data comprise instructions and data which, when read, interpreted, and executed by their respective computers, cause the computers to perform the steps necessary to execute the steps or elements of the present invention. The computer programs and data are usually embodied in or readable from a computer-readable device, medium, or carrier, e.g., a local or remote data storage device or memory device coupled to the computer directly or coupled to the computer via a data communications device.

Thus, the present invention may be implemented as a method, apparatus, or article of manufacture using standard programming and/or engineering techniques to produce software, firmware, hardware, or any combination thereof. The term “article of manufacture” (or alternatively, “computer program carrier or product”) as used herein is intended to encompass one or more computer programs and/or databases accessible from any device, carrier, or media.

Of course, those skilled in the art will recognize that the exemplary environment illustrated in FIG. 1 is not intended to limit the present invention. Indeed, those skilled in the art will recognize that. other alternative environments may be used without departing from the scope of the present invention.

Operation of the Preferred Embodiment

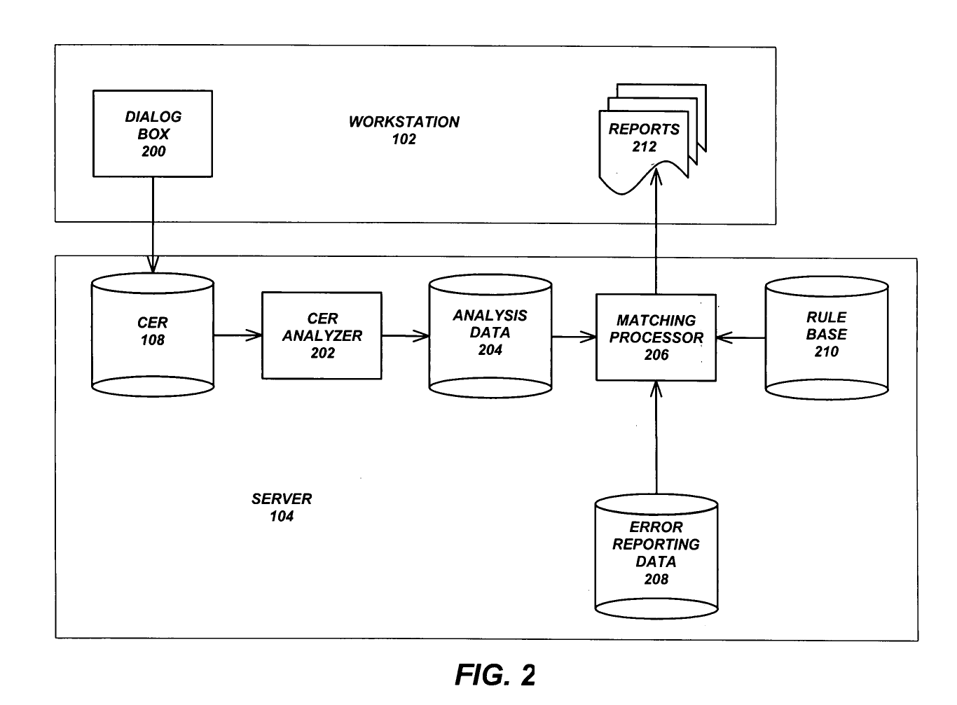

FIG. 2 is a block diagram that illustrates the operation of the preferred embodiment of the present invention. Specifically, the operation of the present invention provides a round-trip resolution of the CER 108. In effect, the user experience of submitting a CER 108 is taken full circle by acknowledging the user's CER 108 submission with a response that reflects the current status of the CER 108.

When a fatal error is encountered during execution of the workstation program 106, a dialog box 200 is displayed on the workstation 102. In one embodiment, the dialog box 200 provides data entry fields for the user to enter a description of the steps necessary to reproduce the error, an email address for the user, and authorization to send the CER 108 to the vendor, which are then included with the CER 108. The dialog box 200 also allows the user to initiate the transfer of the CER 108 from the workstation 102 to the server 104.

As noted above, the CER 108 typically includes a “dump” of at least a portion of the memory in the user's workstation 102, or any other information that may be considered useful by the vendor. In addition, the CER 108 includes an identifier of the workstation program 106 that failed, an identifier of the workstation 102 itself, as well as the data entered by the user into the dialog box 200.

The CER 108 is then sent to the server 104 for analysis.

The server 104 receives the CER 108 from the workstation 102, and a CER analyzer 202 analyzes the CER 108 in order to generate analysis data 204. The CER analyzer 202 performs an automated analysis of the CER 108 to identify the error(s) involved (e.g., memory violations, invalid pointer references, out-of-bounds array accesses, application programming interface (API) errors, etc.).

A matching processor 206 accesses the analysis data 204, as well as error reporting data 208 gathered, for example, from CERs 108 sent by other users. The matching processor 206 executes a matching algorithm based on pre-defined rules 210 that correlates or compares the analysis data 204 with the error reporting data 208, and identifies areas of overlap based on the comparison to determine patterns of errors that lead to the failures described in the CERs 108. The areas of overlap may include any type of information that is the same or similar in both the analysis data 204 and the error reporting data 208. The comparison may be conducted on a line, module, object type, function name, etc., basis.

If the CER analyzer 202 and/or matching processor 206 determine that corrections exists for the workstation program 106 failures, e.g., that the error has been fixed in a new version or service pack that is currently available, then the server 104 sends a resolution report 212 to the workstation 102 that acknowledges the CERS 108, reflects a current status of the CERs 108, and includes the corrections for the program 106 failures.

This resolution report 212 may be sent in real-time to the workstation 102 for display within a dialog box, or the resolution report 212 may be sent in a delayed fashion to the workstation 102 via an email message.

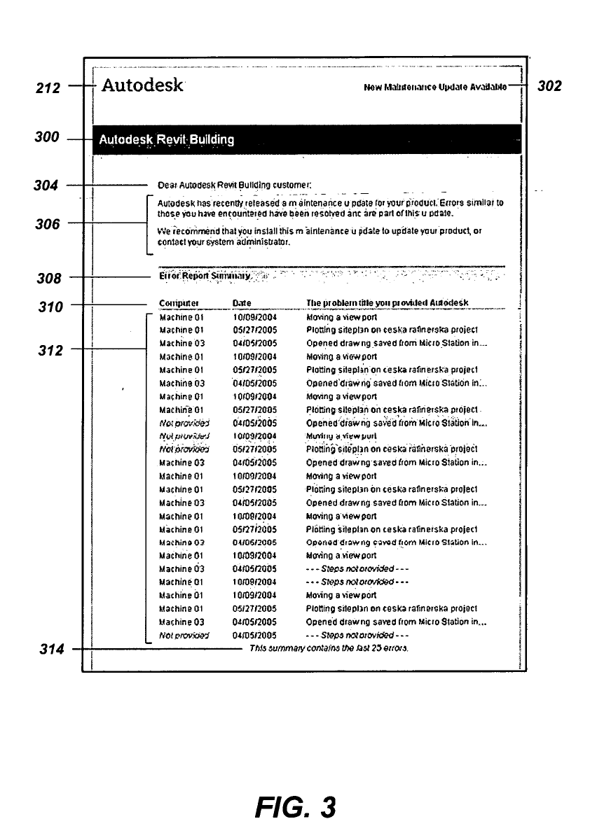

FIG. 3 illustrates one embodiment of the resolution report 212 according to the preferred embodiment of the present invention. In this embodiment, the resolution report 212 comprises a “Resolution List” dialog box or email that is sent to the user when the reported error is believed to be resolved.

The “Resolution List” dialog box or email identifies the product at issue at 300, and contains a Download section 302, opening portion (i.e., “Dear . . . customer”) 304, letter text 306 describing the reason for the report 212, and an Error Report Summary section 308.

The Download section 302 displays a link to download a new version or service pack for the workstation program 106 believed to resolve the listed errors. Typically, the new version or service pack includes an associated “Readme” file that describes the errors being fixed, as well as installation issues.

The Error Report Summary section 308 includes a heading 310 that identifies each column as the user's machine name (if available, otherwise “Not provided”), CER date and the problem title or steps (if available, otherwise “ - - - Steps not provided - - - ”) provided for each CER 108 forwarded to the server 104. Underneath the heading 310 are entries 312 for each of the CERs 108. Finally, a note 314 at the bottom indicates the number of entries 312 in the Error Report Summary section 308.

Conclusion

This concludes the description of the preferred embodiment of the invention. The following describes some alternative embodiments for accomplishing the present invention.

For example, any type of computer, such as a mainframe, minicomputer, work station or personal computer, or network could be used with the present invention. In addition, any software program, application or operating system could benefit from the present invention. It should also be noted that the recitation of specific steps or logic being performed by specific programs are not intended to limit the invention, but merely to provide examples, and the steps or logic could be performed in other ways by other programs without departing from the scope of the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method of providing round-trip resolution to customer error reporting, comprising:
(a) receiving customer error reports concerning program failures from one or more customer computers at a vendor computer;
(b) analyzing the customer error reports in the vendor computer to determine whether corrections exist for the program failures; and
(c) responding to the customer error reports by sending a resolution report including the corrections for the program failures from the at vendor computer to the customer computers.

2. The method of claim 1, wherein the customer error reports include a description of the steps necessary to reproduce the error, an email address for the user, and authorization to send the customer error report.

3. The method of claim 1, wherein the customer error reports include an identifier of the program that failed and an identifier of the customer computer.

4. The method of claim 1, wherein the resolution report includes a link to download a new version or service pack.

5. The method of claim 1, wherein the resolution report is sent in real-time for display to the customer computer.

6. The method of claim 1, wherein the resolution report is sent in an email to the customer computer.

7. The method of claim 1, wherein the resolution report acknowledges the customer error reports.

8. The method of claim 1, wherein the resolution report reflects a current status of the customer error reports.

9. An apparatus for providing round-trip resolution to customer error reporting, comprising:
one or more computers; and
logic, performed by the computers, for:
(a) receiving customer error reports concerning program failures from one or more customer computers;
(b) analyzing the customer error reports to determine whether corrections exist for the program failures; and
(c) responding to the customer error reports by sending a resolution report including the corrections for the program failures to the customer computers.

10. The apparatus of claim 9, wherein the customer error reports include a description of the steps necessary to reproduce the error, an email address for the user, and authorization to send the customer error report.

11. The apparatus of claim 9, wherein the customer error reports include an identifier of the program that failed and an identifier of the customer computer.

12. The apparatus of claim 9, wherein the resolution report includes a link to download a new version or service pack.

13. The apparatus of claim 9, wherein the resolution report is sent in real-time for display to the customer computer.

14. The apparatus of claim 9, wherein the resolution report is sent in an email to the customer computer.

15. The apparatus of claim 9, wherein the resolution report acknowledges the customer error reports.

16. The apparatus of claim 9, wherein the resolution report reflects a current status of the customer error reports.

17. An article of manufacture embodying logic for providing round-trip resolution to customer error reporting, the logic comprising:
(a) receiving customer error reports concerning program failures from one or more customer computers at a vendor computer;
(b) analyzing the customer error reports in the vendor computer to determine whether corrections exist for the program failures; and
(c) responding to the customer error reports by sending a resolution report including the corrections for the program failures from the at vendor computer to the customer computers.

18. The article of claim 17, wherein the customer error reports include a description of the steps necessary to reproduce the error, an email address for the user, and authorization to send the customer error report.

19. The article of claim 17, wherein the customer error reports include an identifier of the program that failed and an identifier of the customer computer.

20. The article of claim 17, wherein the resolution report includes a link to download a new version or service pack.

21. The article of claim 17, wherein the resolution report is sent in real-time for display to the customer computer.

22. The article of claim 17, wherein the resolution report is sent in an email to the customer computer.

23. The article of claim 17, wherein the resolution report acknowledges the customer error reports.

24. The article of claim 17, wherein the resolution report reflects a current status of the customer error reports.
